(19) United States
(12) Patent Application Publication
(10) Pub. No.: US 2023/0309530 A1
(43) Pub. Date: Oct. 5, 2023

(54) SYSTEM FOR STORING, RETAINING, AND CARRYING A PLURALITY OF FISHING LURES

(71) Applicant: Atollas, LLC, Charleston, SC (US)

(72) Inventors: Roland F. Wagner, JR., Carleston, SC (US); Shea Tighe, Charleston, SC (US)

(21) Appl. No.: 17/702,076

(22) Filed: Mar. 23, 2022

(51) Int. Cl. A01K 97/06; A45F 5/00

(52) U.S. Cl. CPC A01K 97/06; A45F 5/00; A45F 2200/05

(57) ABSTRACT

A system for storing, retaining, and carrying a plurality of fishing lures is disclosed. The system includes a first part comprising a base front side and a base back side, an attaching element disposed on the base back side, and a pad disposed on the base front side. The pad is configured to receive a barb of a fishing lure. The system also includes a second base including a second base front side and a second base back side, a second attaching element disposed on the second base back side, and a receiving element disposed on the second base front side. In a storage configuration, the receiving element removably receives the attaching element of the first part and wherein the second attaching element is secured to an article. In an operational configuration, the attaching element attaches to a second article remote from the second part.

### CROSS-REFERENCE TO RELATED APPLICATIONS

This application claims the benefit of the filing date of U.S. Provisional Application Serial No. 63/189,494, entitled “A SMALL CARD SIZED FLY FISHING LURE KEEPER SYSTEM THAT CLIPS TO A SHIRT OR POCKET” and filed May 5^{th}, 2021, the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of fishing equipment, and more specifically to the field of fishing tackle storage systems and devices.

### BACKGROUND

Fly fisherman are faced with limitations when choosing where and how to store their fly lures. An artificial fly, or fly lure, is a very small fishing hook decorated with minuscule pieces of animal fur, feathers, thread, or any other material that resembles a fly’s appearance. Fly fisherman will have an assortment of flies appropriate for each type of fish they intend to catch. These fly lures are usually stored inside containers, such as tackle boxes or boat compartments when not in use and placed in a separate more mobile container when in use. Furthermore, fly lures will sometimes be attached directly to the clothing of the fisherman for easy access while fishing in the water away from their vessel. The current system for storing, retaining, and carrying a plurality of fishing lures may be considered flawed and over complicated. Current devices made for storing fly lures are limiting in the sense that they are stationary and kept in only one place on or with the fly fisherman. These systems include storing fishing lures in containers such as rigid tackle boxes or soft tackle bags, as well as utilizing objects or clothing nearby to temporarily store the lures. Rigid containers used for storing fishing lures can be cumbersome and irritating when needing to fit into certain areas when space is limited. Soft tackle bags are not practical for small fly lures due to the soft material along with the likelihood of a fisherman getting injured by reaching in a compartment to retrieve a fly lure. Both tackle boxes and tackle bags are inefficient for fly fisherman due to their size and limited portability. Lastly, storing lures on clothing or objects nearby can increase the likelihood of accidents occurring. Accidents include the tearing or ripping of clothing, loosing lures by misplacing them or by placing the lures in an unsecure location, or even harming oneself by movement causing the barb of a fishing lure to impale the fisherman. Regarding small lures such as fly lures, the current art lacks portability and versatility. Many devices are too bulky to carry easily while not being invasive to the fisherman.

As a result, there exists a need for improvements over the prior art and more particularly for a more efficient way of storing and carrying fishing lures. There is a need for a smaller, less invasive way to store, retain, and carry fishing lures. If a person wants to fish for only one or two types of fish, they would only need to bring a few different fishing lures with them. To store the lures safely and efficiently, they would need a small, compact device that is easily accessible to the fisherman. Much of the prior art having large carriers with multiple compartments is excessive to fisherman wishing to stay minimal on the water or in the water while fishing.

### SUMMARY

A system for storing, retaining, and carrying a plurality of fishing lures is disclosed. This Summary is provided to introduce a selection of disclosed concepts in a simplified form that are further described below in the Detailed Description including the drawings provided. The Summary is not intended to identify key features of the claimed subject matter. Nor is this Summary intended to be used to limit the claimed subject matter’s scope.

In one embodiment, the system comprises a first part comprising a base front side and a base back side, an attaching element disposed on the base back side, and a pad disposed on the base front side, where the pad is configured to receive a barb of a fishing lure. The system also comprises a second base comprising a second base front side and a second base back side, a second attaching element disposed on the second base back side, and a receiving element disposed on the second base front side. In a storage configuration the receiving element removably receives the attaching element of the first part and wherein the second attaching element is secured to an article, and wherein in an operational configuration, the attaching element is configured to attach to a second article remote from the second part.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a back perspective view of a fishing lure system for storing, retaining, and carrying a plurality of fishing lures, according to an example embodiment.

FIG. 2A is front perspective view of the fishing lure system having a plurality of fishing lures, according to an example embodiment.

FIG. 2B is second front perspective view of the fishing lure system having a plurality of fishing lures, according to an example embodiment.

FIG. 3 is a side view of the fishing lure system, according to a second example embodiment.

FIG. 4 is a side view of the fishing lure system in a storage configuration having a second part secured to an article remote from a first part, according to an example embodiment.

FIG. 5 is a side view a first part of the fishing lure system attached to an article remote from the second part in an operational configuration, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a small, compact, and portable storage device for a plurality of small fishing lures. The claimed invention is light, small, and includes a slip on clip that may be attached in multiple locations on the fly fisherman’s clothing or gear providing the fisherman with options as to where they want to store their fishing lures. The device is also able to be removed and stored separately from other gear or clothing when not in use. The prior art requires the fisherman to carry alongside a type of tackle box or bag to store their lures in. The box or bag will need to be tied to the fisherman or set on a surface away from the fisherman. This tackle box or bag will contain the lures for the fisherman while in use and not in use.

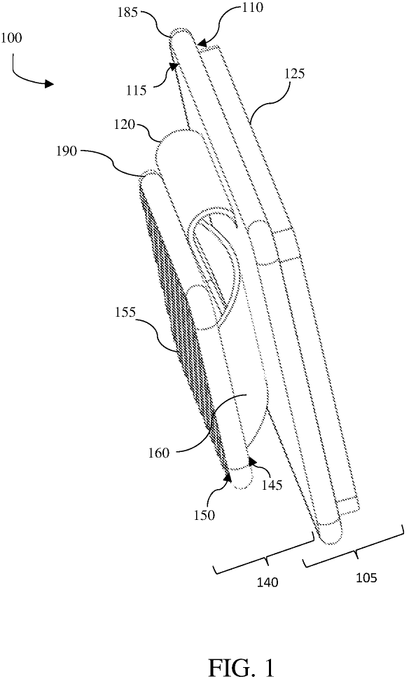

Referring now to the Figures, FIG. 1 is a back perspective view of a fishing lure system 100 for storing, retaining, and carrying a plurality of fishing lures, according to an example embodiment. The fishing lure system includes a first part 105, that has a base 185 consisting of a base front side 110 and a base back side 115. The shape of the base may be any ornamental shape such as a rectangle, circle, etc. The base may be formed from a single piece or from several individual pieces formed or coupled together. The ideal manufacturing process used to form the base is an injection molding process with a stainless steel tooled custom mold. The base may also be manufactured from a variety of different processes including an extrusion process, a mold, welding, shearing, punching welding, folding etc. However, other types of processes may also be used and are within the spirit and scope of the present invention. The base may be made from wood and/or plastic materials such as acrylonitrile-butadiene-styrene, otherwise known as ABS; however, other materials may also be used and are within the spirit and scope of the present invention. In the example embodiment shown, the size of the base should ideally resemble the length and height of a credit card however, in other embodiments, the size may vary based on the size of the fishing lures or flies. For example, a fisherman who uses larger tackle may require a larger sized pad. As such, the dimensions of at least the first part may be larger to be configured to hold the tackle. In other embodiments, the size and dimensions may vary based on manufacturing, material, etc. It is understood that various sizes and shapes of the base are within the spirit and scope of the invention.

The first piece also includes an attaching element 120 located on the base back side. The attaching element may be in the form of a clip, magnet, hook and loop fastener such as Velcro, etc. Ideally, the attaching element will be in the form of a slip clip, however other embodiments may use other forms. The attaching element is the element that is configured in contact with the fisherman. This clip can be used to attach to clothing or gear and when not in use may be attached to the docking apparatus also known as the second part. As the attaching element varies by form, the size and shape may vary as well. The attaching element is small and not intrusive, ideally the size of the attaching element will be smaller than the front side of the base to maintain its simplistic design. The attaching element may be made from a variety of materials including plastic such as acrylonitrile-butadiene-styrene. The material should be lightweight to improve upon the prior art. Like the base, the attaching element may be manufactured from a variety of different processes including an extrusion process, a mold, welding, shearing, punching welding, folding etc. The ideal manufacturing process would be injection molding using a stainless steel tooled custom mold, however, other types of processes may also be used and are within the spirit and scope of the present invention.

Lastly, the first part includes a pad 125 disposed on the back side, where the pad is configured to receive a barb 130 of a fishing lure 135. Ideally the pad will be attached to a base however in some embodiments the pad may act as the base itself attaching to the front side of the first part. The shape of the pad may correspond to the shape of the base with varying thickness dependent on the size of the fishing lures. Ideally the pad will be manufactured by a CNC routing process to produce the exact size and shape to fit and attach to the first part back side, however other types of processes may also be used and are within the spirit and scope of the present invention. The material that the pad may be produced from includes foam such as closed cell foam. Closed cell foam has many properties that are beneficial to this system such as high buoyancy, water resistant, and high tensile strength. Other materials may also be used and are within the spirit and scope of the present invention. The pad will be attached to the base front side by an adhesive, such as epoxy adhesives, polyurethane adhesives, or simply paste.

Now looking at a second part 140, which includes a second base 190, having a second base front side 145 and a second base back side 150. The second part acts as a docking apparatus when the first part is not in use. This piece makes the system extremely versatile. The user may have a single second part or may have a plurality of second parts to increase accessibility. The shape of the base may be any ornamental shape such as a rectangle, circle, etc. The second base front side and the second base back side may be made of a rubber such as silicon, however, other materials may also be used and are within the spirit and scope of the present invention. Ideally, the second part will be produced by an injection molding process with a stainless steel tooled custom mold, however, other types of processes may also be used and are within the spirit and scope of the present invention.

The second part also includes a second attaching element 155 and a receiving element 160. The second attaching element may comprise an adhesive and may be a pressure sensitive adhesive. The second attaching element may be placed onto any surface such as a window, a car dash, a surface on a boat, etc. due to its adhesive properties. In another embodiment, the attaching element may be in the form of a magnet. Ideally, this attaching element will be produced through a CNC routing or laser cutting process to produce the exact size and shape to attach to the bases back side. However, other methods may be used and are within the spirit and scope of the invention. The adhesive of the second attaching element may be a pressure sensitive adhesive comprising materials such as comprise lanolin, mineral oil, petrolatum, rosin, silicone, and zinc oxide. The backing may be made of material such as wax paper or other materials used to protect adhesive materials.

The receiving element is configured as a slip cavity to fit the attaching element from the first part; however the element may also be configured to operatively interact with the first part attaching element such as a magnet or hook and loop fastener. This element may be in the form of a loop in some embodiments, in other embodiments the element may take the form of the negative area of the first part attaching element. The receiving element may be manufactured from a variety of different processes including via a CNC lathe, extrusion, a mold, welding, shearing, punching welding, folding etc. The material used for this receiving element may be made of a rubber such as silicon, other materials may also be used and are within the spirit and scope of the present invention.

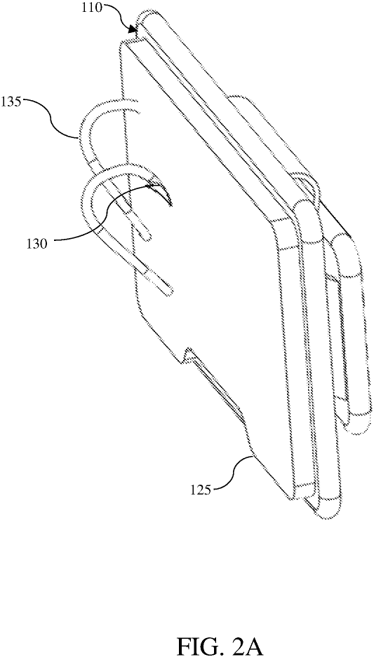

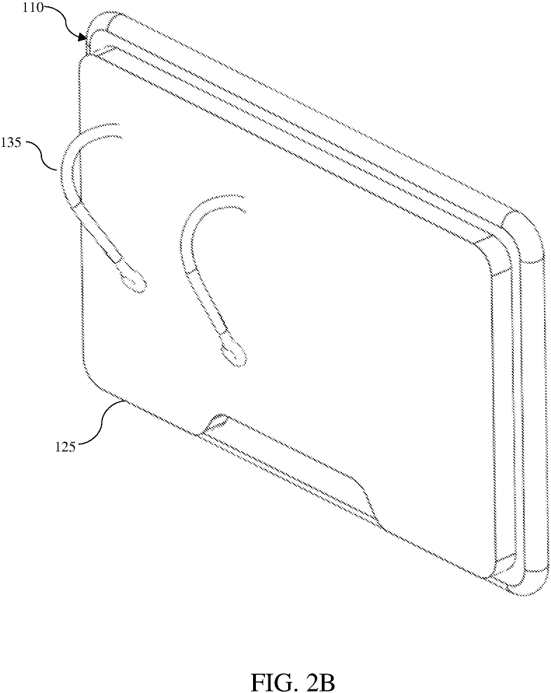

Referring now to FIGS. 2A-2B, a front perspective view of the fishing lure system having a plurality of fishing lures is shown, according to an example embodiment. FIG. 2A illustrates a hook 130 from a fishing lure 135 being inserted into the pad 125 located on the first part back side 135. The pad, containing a large enough surface area to provide room for a plurality of fishing lures. This embodiment shows the device in operational configuration. The user may insert the desired fishing lures into the pad securing them for use. FIG. 2B showing the fishing lures fully inserted into the pad. This illustration may be viewed as storage configuration with the fishing lures already secured into the pad for safe keeping.

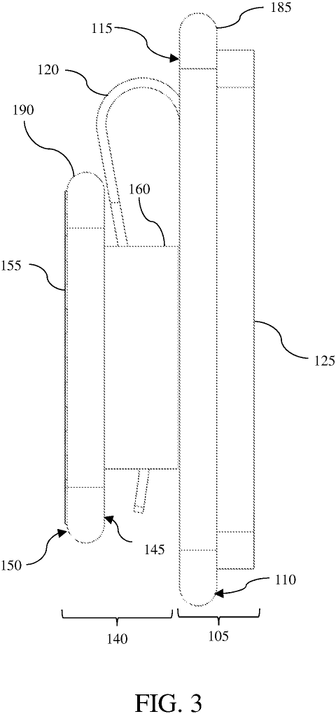

Referring now to FIG. 3, a side view of the fishing lure system is shown, according to a second example embodiment. As stated above, the figure illustrates the system that may further be configured to store the fishing lures or may be configured to use the fishing lures.

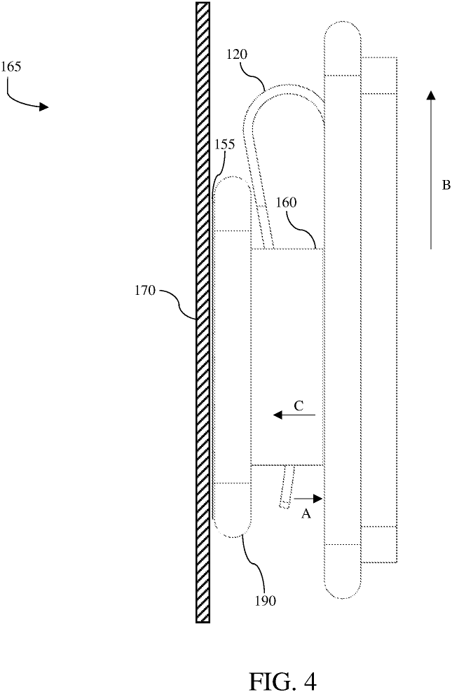

Referring now to FIG. 4, a side view of the fishing lure system in a storage configuration 165 having a second part secured to an article 170 remote from a first part is shown, according to an example embodiment. The article may be a boat console, car visor, cooler, etc. This embodiment shows how versatile the system is. The storage configuration allows the user to decide where the most convenient location to store the device would be, as stated above they may attach the second piece to something stationary like a vehicle dash or something portable such as a tackle box if they wish to do so. To use the device in storage configuration, the user may first remove the backing off the second part’s attaching element. Once the adhesive is exposed the user then places the second part onto an article of their choosing, such as a boat console or car visor. The second part is now secure. Now the user may attach the first part’s attaching element to the second part’s receiving element. These elements may be in the form of a clip and a slip cavity to ensure security. In one embodiment, the clip provides a biasing force in the direct of arrowed line A. The clip is configured such that force in the direction of arrowed line A retains the clip on the receiving element. In operation, to remove the clip from the receiving element, a user will apply a force in the direction of arrowed line B such that a force in the direction of arrowed line C is greater than the force in the direction of arrowed line A allowing the clip to be removed.

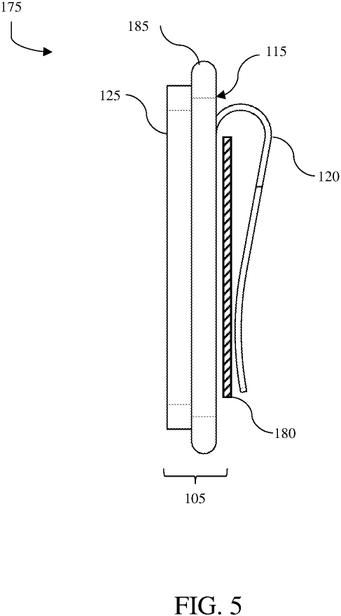

Referring now to FIG. 5, a side view of a first part of the fishing lure system attached to a second article 180 remote from the second part in an operational configuration 175 is shown, according to an example embodiment. In operational configuration, the second article may be in the form of a piece of clothing such as a shirt pocket, a sleeve, a belt, etc. In other embodiments the second article may be a piece of equipment on a vessel such as a handle or rope near the fisherman. The second article can be anything the fisherman wishes it to be. To use the device in operational configuration, the user will apply a force onto the pad, via the fishing lure’s barb, causing the hook to penetrate the pad thereby retaining the tackle. However, in other embodiments the pad may be comprised of an adhesive, allowing the tackle to stick once the force is applied. Once the desired fishing lures are secure, the user may then attach the first part to an article of choice by inserting the attaching element onto the article such as a belt. If the attaching element is in the form of a clip, the user will force the clip to compress allowing a gap to form. The user then will insert the article and release the clip forcing tension to grip the article secure. The system is now in operational configuration, prepared for movement and versatility.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A fishing lure system for storing, retaining, and carrying a plurality of fishing lures, the fishing lure system comprising:
a. a first part comprising:
i. a base comprising a base front side and a base back side;
ii. an attaching element disposed on the base back side;
iii. a pad disposed on the base front side, wherein the pad is configured to receive a barb of a fishing lure;
b. a second part comprising:
i. a second base comprising a second base front side and a second base back side;
ii. a second attaching element disposed on the second base back side;
iii. a receiving element disposed on the second base front side; and
c. wherein in a storage configuration the receiving element removably receive the attaching element of the first part and wherein the second attaching element is secured to an article, and wherein in an operational configuration, the attaching element is configured to attach to a second article remote from the second part.

2. The fishing lure system of claim 1, wherein the attaching element is a clip.

3. The fishing lure system of claim 2, wherein the second attaching element comprises one of a pressure sensitive adhesive, a suction cup, and a magnet.

4. The fishing lure system of claim 3, wherein the pad comprises at least one of EVA foam, cork, slitted EVA foam, silicone, wood.

5. The fishing lure system of claim 4, wherein the second article is at least one of a shirt, a belt, a pocket, a hat, a pair of shorts, a pair of pants, a backpack, a tackle box.

6. A fishing lure system for storing, retaining, and carrying a plurality of fishing lures, the fishing lure system comprising:
a. a first part comprising:
i. a base comprising a base front side and a base back side;
ii. an attaching element disposed on the base back side;
iii. a pad disposed on the base front side;
b. a second part comprising:
i. a second base comprising a second base front side and a second base back side;
ii. a second attaching element disposed on the second base back side; and
iii. a receiving element disposed on the second base front side.

7. The fishing lure system of claim 6, wherein the pad is configured to receive a barb of a fishing lure.

8. The fishing lure system of claim 6, wherein in a storage configuration the receiving element removably receive the attaching element of the first part and wherein the second attaching element is secured to an article.

9. The fishing lure system of claim 6, wherein in an operational configuration, the attaching element is configured to attach to a second article remote from the second part.

10. The fishing lure system of claim 6, wherein the attaching element is one of a clip and a carabiner.

11. A fishing lure system for storing, retaining, and carrying a plurality of fishing lures, the fishing lure system comprising:
a. a pad having a pad back side;
b. a clip disposed on the pad back side;
c. a loop configured to receive the clip;
d. an adhesive element in attachment with the loop; and
e. wherein the pad and the clip are independent from and removably attachable to the loop and the adhesive element.

12. The fishing lure system of claim 11, wherein the pad and the clip define a first part.

13. The fishing lure system of claim 12, wherein the loop and the adhesive element define a second part.

14. The fishing lure system of claim 13 wherein the system comprise a portable configuration wherein the first part is removably attached to an article remote from the second part, and wherein the second part is removably attached to a second article remote from the first part.

15. The fishing lure system of claim 13 wherein the system comprise a storage configuration wherein the first part is removably attached to the second part, and wherein the second part is removably attached to an article remote from the first part.
